(19) United States
(12) Patent Application Publication
(10) Pub. No.: US 2004/0184528 A1
(43) Pub. Date: Sep. 23, 2004

(54) Data processing system, data processing apparatus and data processing method

(75) Inventors: Hideki Miyasaka, Kawasaki (JP); Kaname Yoshida, Kawasaki (JP); Yasuo Misuda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 10/763,208

(22) Filed: Jan. 26, 2004

(30) Foreign Application Priority Data
Mar. 19, 2003 (JP) 2003-076335

(51) Int. Cl. H04N 7/12; H04N 7/18

(52) U.S. Cl. 375/240.01; 348/143; 348/149

(57) ABSTRACT

In a data processing system in which a plurality of data processing apparatuses are connected together via a communication network, each of the plurality of data processing apparatuses includes a data acquisition part obtaining data which should be processed; a data analysis part performing predetermined data analysis on the obtained data; a data unit identification part identifying the obtained data as a data unit for each event; and a determining unit determining for each data unit according to a predetermined condition whether the predetermined data analysis is performed on the obtained data should be processed in the own apparatus, or is sent to another apparatus and is performed on by the anointer apparatus the predetermined data analysis.

### BACKGROUND OF THE INVENTION

1. Field of the Invention

The present invention relates to a data processing system, a data processing apparatus and a data processing method, and, in particular, to a data processing system in which a plurality of data processing apparatuses are connected via a communication network together and each data processing apparatus performs predetermined data analysis on obtained data, and to each data processing apparatus and a data processing method thereof.

2. Description of the Related Art

As an example of the above-mentioned data processing system in which a plurality of data processing apparatuses are connected via a communication network and each data processing apparatus performs predetermined analysis on obtained data, a traffic monitoring system, an intruder watching system, a disaster warning system or so may be considered, each of which systems includes many image sensor apparatuses, each having a TV camera and an image processing apparatus, provided in a scattered manner at specific districts.

Respective image sensor apparatuses applicable to these system are provided in respective districts in a scattered manner, and analyze image data pickup via the TV cameras, recognize therefrom the contents for a predetermined monitoring item, and then transfer the recognized results to a center apparatus or so. Thus, the image sensor apparatus provided in each district has a function of performing a predetermined analysis on the pickup data by means of a computer (MPU or so) in the own apparatus, and transferring the processing result to the center apparatus.

For example, in case of the traffic monitoring system, the above-mentioned image sensor apparatuses are provided along a predetermined road, images of vehicles passing therethrough are taken always so that moving pictures thereof are obtained, and the moving picture data thus obtained is analyzed. As a result, for each vehicle, the type thereof, the number of axles, the size, paint color, moving speed, and so forth are determined and recognized, and the thus-recognized data is transferred to the center apparatus via a communication network. FIG. 1 shows a state in which, via the above-mentioned network 103, the respective sensor apparatuses 101, and the above-mentioned center apparatus 102 are connected.

### SUMMARY OF THE INVENTION

In the above-mentioned example of traffic monitoring system, the traffic volume of vehicles passing through the road is not constant in general. For example, always very few vehicles pass therethrough while many vehicles pass consecutively on occasion. In other words, the frequency at which data to be processed by the above-mentioned image sensor apparatus occurs is small in average, while the data occurs at random in a burst manner. In such a situation, if the performance of the above-mentioned MPU is set by which the given data should be processed always in real time, the specification of the MPU should be excessive with respect to the average required data processing volume. Thus, the costs therefor increase. On the other hand, if an event occurs at a burst such that the performance of the MPU cannot follow a lot of traffic volume which thus temporarily occurs, the processing may be delayed, or, data overflowing may be discarded for the purpose of avoiding such processing delay. If such a situation occurs, the monitoring function which is the essential function of the system may not be secured.

The present invention has been devised in order to solve this problem, and an object of the present invention is to provide a data processing system in which particular data processing apparatuses perform data analysis processing in a load sharing manner for events which occur at random and at a burst, a required analysis processing amount which should be finished can be completed without fail, and also the data processing performance required for each MPU should not amount to a level which is excessive with respect to the average data processing load, while the required data analysis processing can be executed timely.

In order to achieve the above-mentioned object, according to the present invention, in a data processing system in which a plurality of data processing apparatuses are connected together via a communication network, each of the plurality of data processing apparatuses includes: a data acquisition part obtaining data which should be processed; a data analysis part performing predetermined data analysis on the obtained data; a data unit identification part identifying the obtained data as a data unit for each event; and a determining unit determining for each data unit according to a predetermined condition whether the predetermined data analysis performed on the obtained data should be processed in the own apparatus, or should be sent via the communication network to another apparatus and the predetermined data analysis should be performed thereon by the another apparatus.

According to the present invention, the particular data processing apparatus transfers an excessive amount of to-be-processed data to another data processing apparatus so that the other data processing apparatus which receives it performs the data analysis processing thereon instead, when the data amount which should be processed exceeds with respect to the own data processing capability, in other words, when it is determined that the own processing capability is not sufficient to complete the given amount of data to be processed.

Specifically, as mentioned above, in a wide area monitoring system such as that described above, in general, it is unusual that a burst of events, i.e., a phenomenon of temporally increase of traffic volume or so occurs uniformly throughout the entire system covering area. Rather, in many cases, such a matter occurs merely at a limited part of the entire system covering area, while nothing occurs in the other districts. In other words, imbalance in given to-be-processed load for the monitoring system is likely to occur. Accordingly, by transferring the excessive amount of to-be-processed data from the data processing apparatus in which the to-be-processed date excess situation occurs to another data processing apparatus according to the present invention, it is possible to effectively avoid the imbalance in the given to-be-processed load, and thus, the to-be-processed load is evenly shared throughout the whole system. As a result, in each data processing apparatus, it is not necessary to provide therein a data processing capability excessive with respect to the average required data processing volume, while it is possible to positively complete the required analysis processing on the required data processing volume.

Further specifically, in the above-mentioned example of traffic monitoring system, the data analysis which should be performed on the given to-be-processed data includes, for example, to analyze the obtained data for predetermined monitoring items concerning particular vehicles passing through the road. Then, according to the present invention, passing of each vehicle is regarded as an event, and a series of video frames taken corresponding to each vehicle are identified as a data unit. Further, the data thus identified is provided with predetermined identification information for each data unit so that the relevant event can be identified therewith. As a result, even the to-be-processed data is divided for respective data units to be shared by different data processing apparatuses, respectively, analysis processing results obtained from the analysis processing performed by these respective data processing apparatuses can be easily searched for as the above-mentioned predetermined identification information is added to each of the processing results. Thus, it is possible to achieve efficient monitored data processing.

For example, it is assumed that a series of video frames shown in FIG. 2 are taken for passing vehicles. As shown, it is assumed that passing of a first vehicle is identified as an event A, while passing of a second vehicle is identified as an event B. Furthermore, a time interval required for analysis processing (sensing processing) on the event A is assumed as shown at the bottom of FIG. 2. In this case, when real time analysis processing is required for each of the events A and B by the relevant image sensor apparatus, the analysis processing cannot be properly performed in this example by the following reason: That is, since the event B occurs during the analysis processing of the event A, analysis processing for the event B cannot be immediately started as the sensor apparatus is currently occupied for processing of the event A as shown.

Even in such a case, according to the present invention, a series of video frames for the event A and a series of video frames for the event B are identified separately for respective data units, and are then regarded as respective data units. Thereby, it becomes possible that, for example, the series of video frames of the event B may transferred to another image sensor apparatus, and then, are caused to be performed by the other image sensor apparatus instead. As a result, it is possible to achieve effective load sharing for the given data processing load.

### BRIEF DESCRIPTION OF DRAWINGS

Other objects and further features of the present invention will become more apparent from the following detailed description when read in conjunction with the accompanying drawings:

FIG. 1 illustrates a data processing system including image sensor apparatuses connected via a communication network;

FIG. 2 illustrates one example of video data handled by a data processing system in embodiments of the present invention;

FIG. 3 shows a block diagram of a data processing system according to a first embodiment of the present invention;

FIG. 4 shows a block diagram of a data processing system according to a second embodiment of the present invention;

FIG. 5 shows a block diagram of a data processing system according to a third embodiment of the present invention;

FIG. 6 shows a block diagram of a data processing system according to a fourth embodiment of the present invention;

FIGS. 7 and 8 illustrate functions of an object extraction part and an event identification part shown in FIGS. 3 through 6;

FIGS. 9 and 10 illustrate a function of an OSD part shown in FIG. 6;

FIGS. 11 and 12 illustrate functions of a memory controller, a sharing processing determination part and a buffer memory shown in FIGS. 3 through 6; and

FIG. 13 illustrates one example of a configuration a transfer data frame created by a data transfer frame creation part shown in FIGS. 3 and 4.

### DETAILED DESCRIPTION OF THE PREFERRED EMBODIMENTS

Embodiments of the present invention will now be described. First, a feature of moving picture processing as data processing according to the embodiment of the present invention will now be described. In this case, each image sensor apparatus does not process one event as a still image taken, but performs so-called sensing processing with consideration of a series of movement of a target object (for example, a vehicle) based on a series of video frames taken. As a specific example of the sensing processing, a measurement of moving direction, and moving speed of the vehicle, monitoring for a traffic jam, capturing of movement of a possible intruder, monitoring ocean waves in a gulf or for a cliff failure, monitoring for a possible stumbling block or so along a rail way or a road, and so forth may be assumed.

Generally, in case of processing image data with a plurality of data processing apparatuses in a load sharing manner, the following two types of manner may be considered (see Japanese laid-open patent applications Nos. 2001-167246, 2001-285846 and 2002-112216, H02-287680 in this regard):

\mathring{1} to divide each video frame spatially (two-dimensional spatial division), and process the divisions in parallel with a plurality of image sensor apparatuses; and

\mathring{2} to classify required data processing jobs for common image data with respect to the contents of data processing, and process the jobs with a plurality processing apparatuses, respectively.

However, in case of moving picture sensing according to the embodiment of the present invention as mentioned above, sensing is performed with a consideration of movement (direction, speed, or so) of a target. Accordingly, according to the embodiment of the present invention, an interval in which an event occurs is regarded as a processing data unit, and load sharing is achieved for a unit of series of video frames concerning the event. As a result, according to the present invention, the following two functions are mainly needed:

\mathring{1} function of determining whether each particular image sensor apparatus should perform predetermined analysis processing in the own apparatus or should transfer the relevant image data to another image sensor apparatus for the load sharing purpose; and

\mathring{2} function of creating a transfer data (processing data unit) form in case of the image data transfer to the other apparatus.

In this case, it is necessary to prescribe the following matters:

\mathring{1} a transfer data format applied when transferring the image data to another image sensor apparatus; and

\mathring{2} contents of operation which should be executed by the image sensor apparatus which then receives the transferred data.

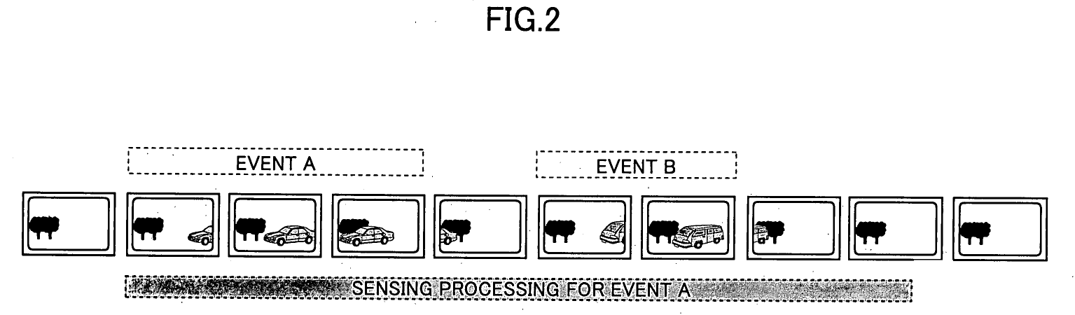

In order to achieve the above-mentioned functions, each image sensor apparatus according to the present invention is configured to divide to-be-processed data to undergo the predetermined sensing processing into a series of video frames for each event; and to transfer the data to another image sensor apparatus connected via the communication network in a unit of the event (a series of video frames) when the data to be processed exceeds its own processing capability, i.e., in the example of FIG. 2, the number of vehicles passing by within a predetermined unit time interval exceeds a predetermined value.

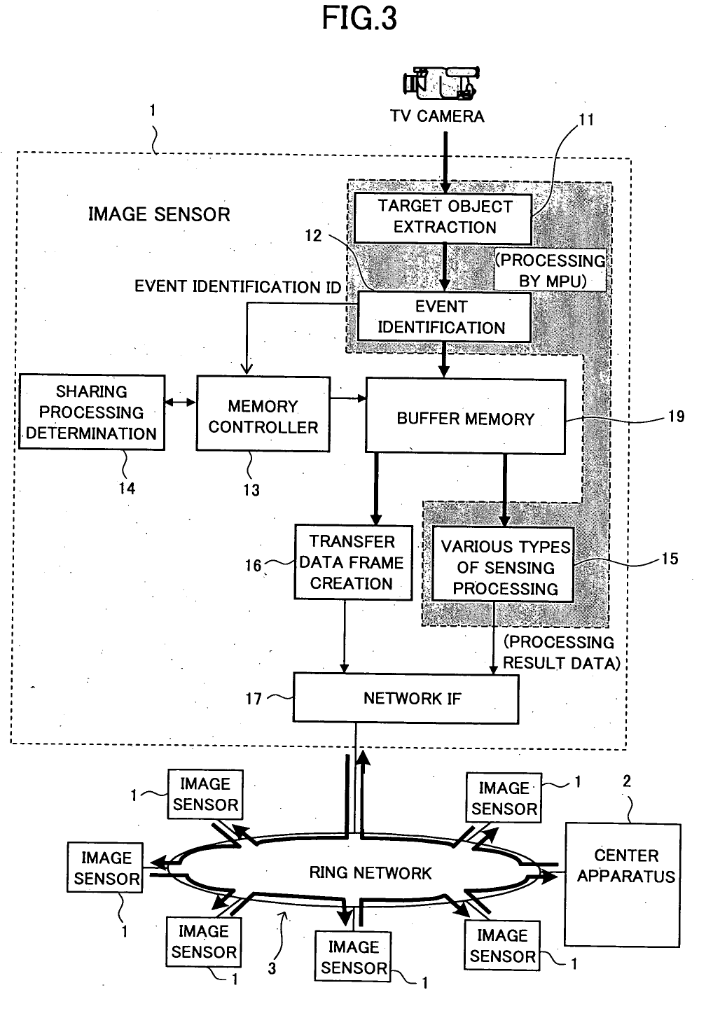

With reference to FIGS. 3 through 6, data processing apparatuses and image sensor apparatuses 1 in a first embodiment, a second embodiment, a third embodiment and a fourth embodiment of the present invention will now be described.

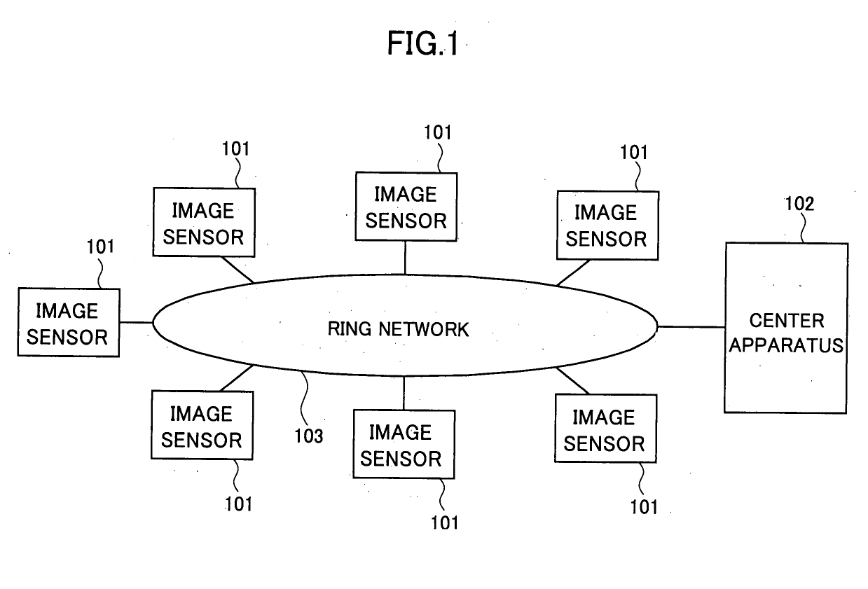

In the first embodiment shown in FIG. 1, each image sensor apparatus 1 includes the following functional parts:

a target object extraction part 11 which extracts an object (target object) to undergo predetermined sensing processing from among input video data;

an event identification part 12 which identifies video frames including the target object for each series of event, sends a relevant event's ID to a memory controller 13, and also, writes only the video frames including the event of the target object to a buffer memory 19;

a memory controller 13 which once writes the video data for each event in the buffer memory 19, and allocates addresses in the buffer memory 19 for reading the video data therefrom for a sensing processing part 15;

a sharing processing determination part 14 which determines according to a remaining storage capacity in the buffer memory 19 whether or not the to-be-processed data should be transferred to another image sensor apparatus 1;

the sensing processing part 15 which performs predetermined sensing processing (data analysis processing) on the series of video frames for each event read out from the buffer memory 19, wherein the contents of specific processing operation depends on a particular application applied thereto, for example, in case where a target object is a vehicle as mentioned above, the moving (running) speed, the vehicle type, the size, the number of axles, the paint color, character/letters described thereon, or so is analyzed by means of image processing technique, and thus, is recognized;

a transfer data creation part 16 which creates a data frame used for transferring the video data of the event to another image sensor apparatus 1 which data cannot be processed by the own processing part 15 in terms of the processing capability thereof, wherein, in this case, the transfer data frame has a transmission source ID, an event ID, an event occurrence time and so forth added thereto as header information (identification information) thereof, where ‘transmission source ID’ is used for identifying the transmission source apparatus (image sensor apparatus 1) in case where to-be-processed data is transferred to another image sensor apparatus by which the predetermined analysis processing is performed on the to-be-processed data instead which data cannot be processed by the own apparatus (image sensor apparatus 1); ‘event ID’ is information of a number for example assigned for each event occurring according to the occurrence order for identifying the occurrence order of the event; and ‘event occurrence time’ is information for identifying the occurrence time, i.e., a record time (year, mouth, date, hour, minute and second) of the event; and

a network IF part 17 which performs predetermined framing processing required according to a particular type of the communications network 3 applied, wherein a specific frame configuration is applied depending on the type of communication network 3 applied.

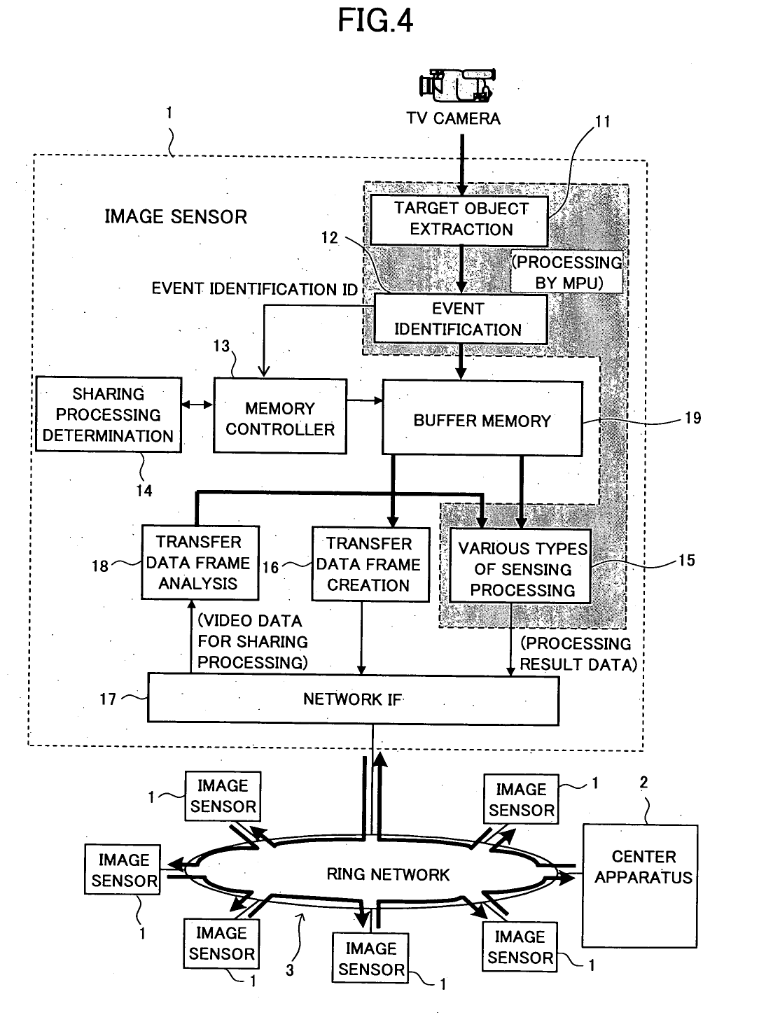

With reference to FIG. 4, an image data processing system according to the second embodiment of the present invention will now be described. There, in addition to the functions of the first embodiment described above, each image sensor apparatus 1 has a function of determining whether or not to take therein to-be-processed data transferred from another image sensor apparatus 1 in consideration to the data processing situation in the own apparatus, and then, so as to perform the above-mentioned sensing processing instead of the transfer-source apparatus.

In order to achieve this function, the sharing processing determination part 14 in the image sensor apparatus 1 monitors the remaining storage capacity in the buffer memory 19 of the own apparatus, and determines whether or not the data transmitted by the communication network 3 from another image sensor apparatus should be taken therein, according to the result of the above-mentioned processing of monitoring the remaining storage capacity in the own buffer memory 19. A transfer data analysis part 18 is provided to analyze the data frames transferred from the other image sensor apparatus when taking the data according to the result of the above-mentioned determination made by the sharing processing determination part 14, and transfers video data obtained from the analysis performed there to the sensing processing part 15 together with the above-mentioned header information.

The sensing processing part 15 stops reading from the buffer memory 19 in the own apparatus in order to process the data transferred from the other image sensor apparatus, and takes the data transferred from the other image sensor apparatus via the transfer data analysis part 18. Then, after performing the predetermined sensing processing, the sensing processing part 15 reports the sensing processing result together with the identification information such as transmission source ID, event ID, event occurrence time and so forth therefor to the center apparatus 2.

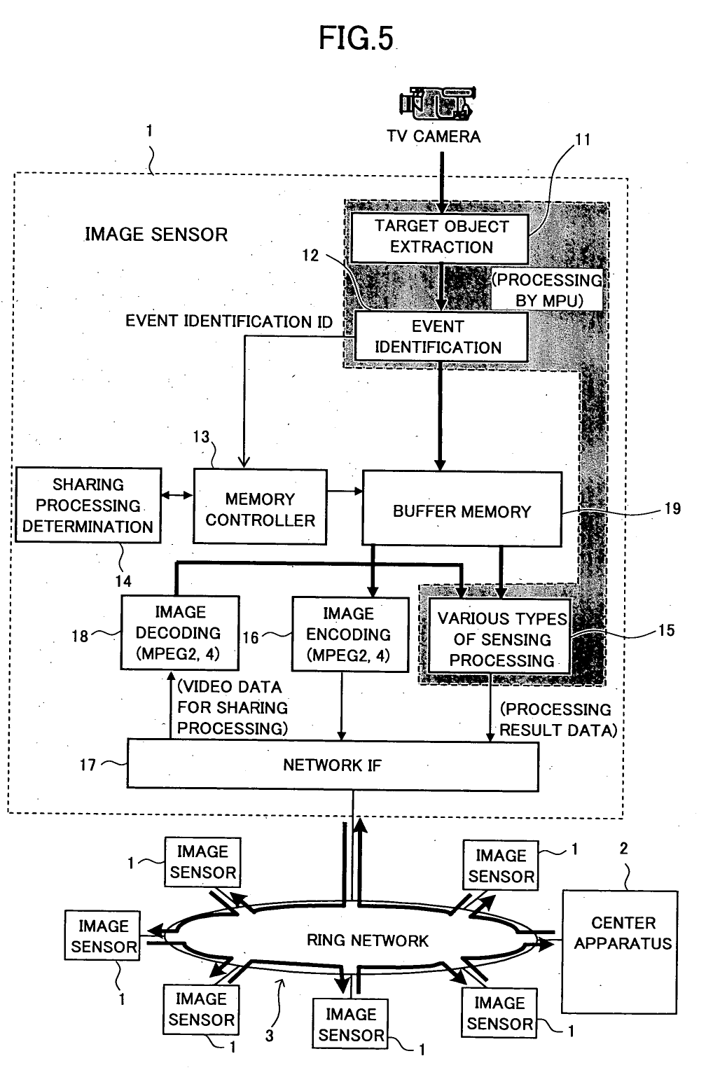

With reference to FIG. 5, an image data processing system according to the third embodiment of the present invention will now be described. In this case, in the configuration according to the first or second embodiment described above, each sensor apparatus 1 performs, upon transferring the to-be-processed data to another image sensor apparatus 1, compression and encoding (according to MPEG2, 4, or so) of the data to be transferred with an image encoding part 16 as the transfer frame creation part, so as to avoid increase in the traffic in the communication network 3.

In the third embodiment, the transfer data creation part 16 of each image sensor apparatus 1 functions as the image encoding part so as to compress and encode the video data upon transferring the video data for the event on which the sensing processing part 15 of the own apparatus cannot perform the predetermined analysis processing, and creates the transfer data frames with a thus obtained data stream. Upon encoding, one event is regarded as one sequence, and a so-called I picture is applied to the top frame thereof. Further, in this case, it is possible to multiplex the identification information such as the transmission source ID, event ID, event occurrence time and so forth of the transfer frames, to a relevant MPEG stream as private data, and thereby, separate processing for creating the transfer frames can be omitted.

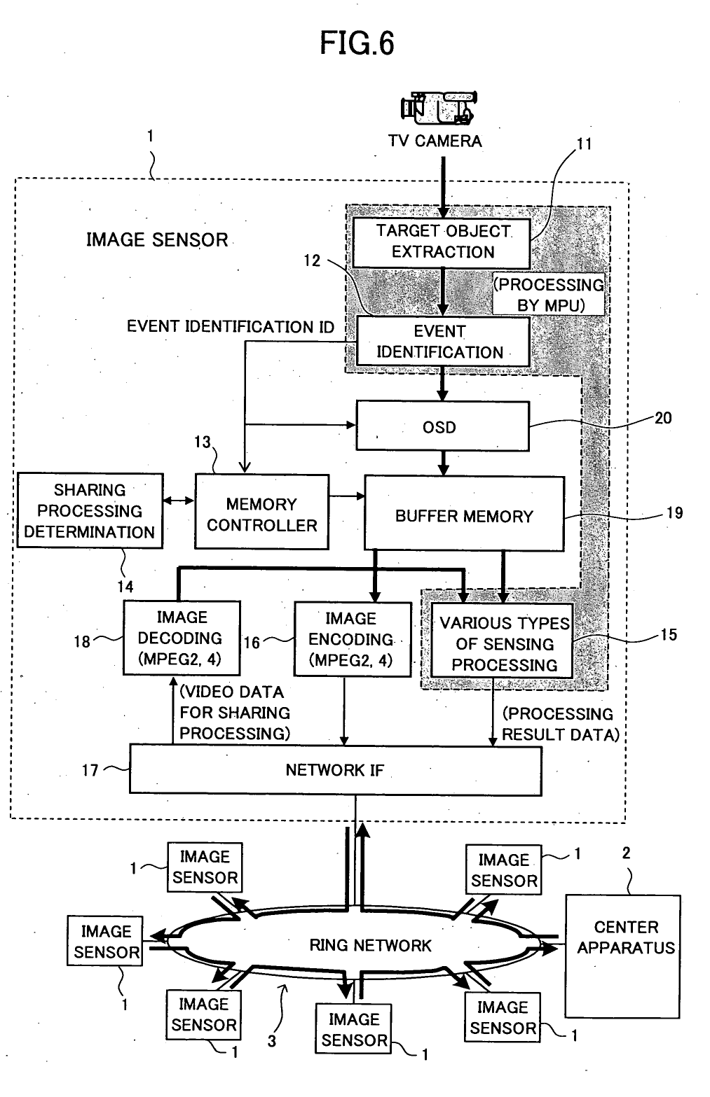

With reference to FIG. 6, an image data processing system according to the fourth embodiment of the present invention will now be described. There, in addition to the functions in the above-mentioned first through third embodiments, each image sensor apparatus 1 has a function of inserting the identification information such as the transmission source ID, event ID, event occurrence time and so forth by performing teletext (text multiplexing/insertion) in a predetermined portion of each video frame upon performing the event identification processing on the obtained video data in the event identification part 12. As a result, separate operation of creation of the transfer data frame needed when transferring the to-be-processed data to another image sensor apparatus 1 can be omitted, and, the image sensor apparatus 1 receiving the thus-transferred data reads the text multiplexed/inserted data through predetermined analysis processing by means of an image processing technique performed on the transferred data in the sensing processing, so as to recognize the contents of the inserted identification information.

In order to achieve the above-mentioned function, the event identification part 12 identifies the video frames including the pickup target for each series of event, sends the relevant event ID to the memory controller 13 and an OSD (on screen display) part 20, and thus sends only the video frames including the target event to the OSD part 20. The OSD part 20 adds/inserts the event ID and predetermined transmission source ID and time information to a predetermined place in each of the thus-sent video frames via text multiplexing/insertion processing (with a use of a teletext technique, for example) so as to create the transfer data, and writes the thus-obtained data in the buffer memory 19.

The function of each functional part described above in each embodiment will now be described separately.

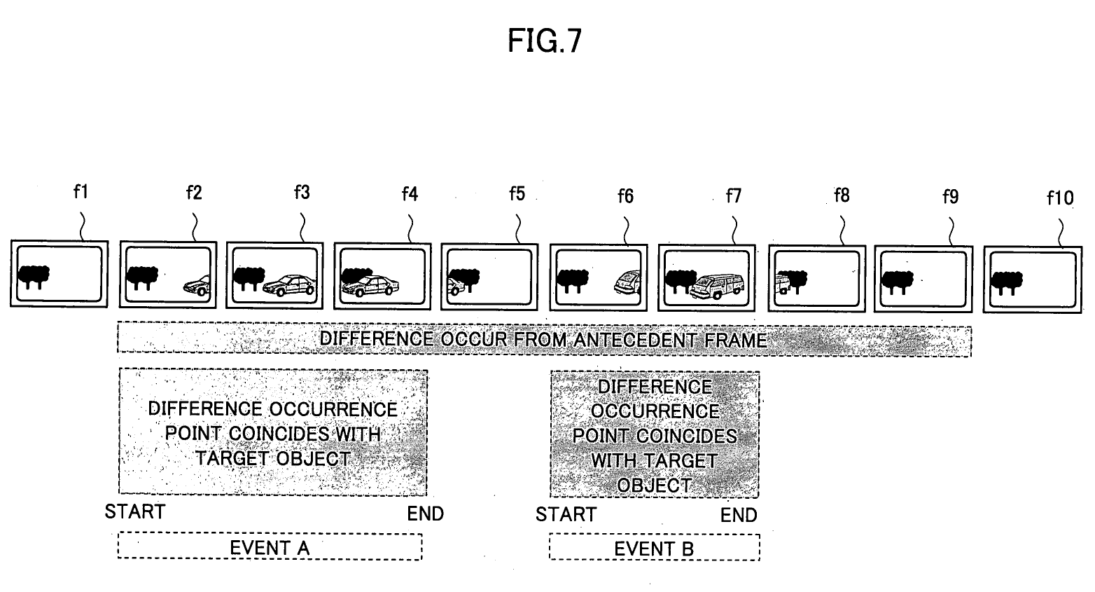

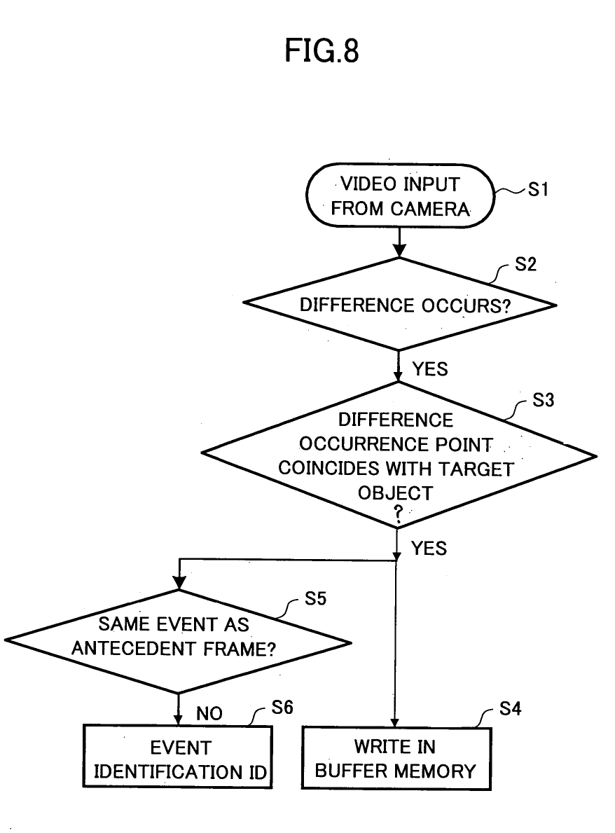

First, the functions of the object extraction part 11 and event identification part 12 of each image sensor apparatus 1 of each embodiment will now be described with reference to FIGS. 7 and 8. FIG. 7 illustrates respective frames of road condition video taken by a TV camera provided in each image sensor apparatus 1 along time axis. FIG. 8 shows a flow chart of operation performed by the object extraction part 11 and event identification part 12. Each frame taken by means of the TV camera (in Step S1), i.e., a video frame is compared with an immediately antecedent video frame, and a difference therebetween (inter-frame difference) is obtained by predetermined operation. Then, in Step S2, when it is determined from the operation result that a substantial difference occurs, it is determined in Step S3 whether or not the contents of this difference correspond to a predetermined target object.

Specifically, the above-mentioned inter-frame difference is obtained from comparison in corresponding pixel value between video frames, for example. As the TV camera performs picture pickup at a fixed location, it pickups merely a background when no vehicle passes by (see frames f9 and f10 of FIG. 7). Accordingly, in this case no substantially difference occurs in corresponding pixel value between adjacent frames. On the other hand, when a vehicle or so passes by (see frame f2), a change occurs in the picture, and as a result, the inter-frame difference occurs (Yes in Step S2). According to the present embodiment, the above-mentioned predetermined object is a vehicle, and, in order to determine whether or not the moving object taken is a vehicle, it is determined whether or not an oblique boundary part having a length (in other words, whether or not approximately same pixel values continue approximately spatially along a straight line) corresponding to a bumper of a vehicle occurs at a predetermined height range (coordinate range) in the taken picture is detected. If the corresponding boundary part is detected (Yes in Step S3), it is determined that a vehicle which is the target object passes by, and in this case, the relevant video frame is written in the buffer memory 19 (Step S4). Otherwise (No in Step S3), it is determined that the inter-frame difference detected in Step S2 does not correspond to a target object, and the relevant video frame is thus discarded.

In Step S5, it is determined whether or not the above-mentioned inter-frame difference contents correspond to the same target object as that in the antecedent frame. In other words, when the boundary part corresponding to the vehicle's bumper detected as mentioned above merely moves horizontally between the two video frames (see frames f2 and f3), it is determined that the boundary parts correspond to the same target object. However, otherwise, for example, as in the frame f6 of FIG. 7, that is, in a case where the above-mentioned boundary part corresponding to a vehicle's bumper suddenly occurs which did not occur in the immediately antecedent frame 5, or in case where two vehicles pass by successively, it is determined that the above-mentioned boundary part corresponding to a vehicle's bumper is different from that detected in the immediately antecedent frame (No in Step S5), and then, the event ID is updated and is written corresponding to the relevant video frame in the buffer memory 19 (Step S6).

By this processing, for a series of video frames (f2 through f4, or f6 through f7) which are determined as to include an inter-frame difference corresponding to a same target object, are identified as to belong to a series data unit concerning a same event, and are written in the buffer memory 19 with a same event ID assigned thereto.

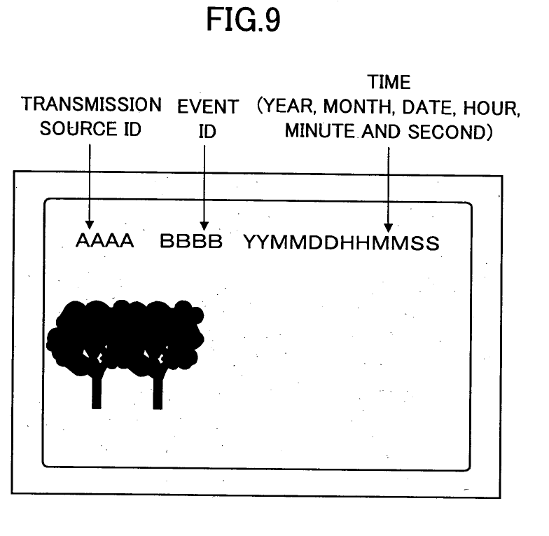

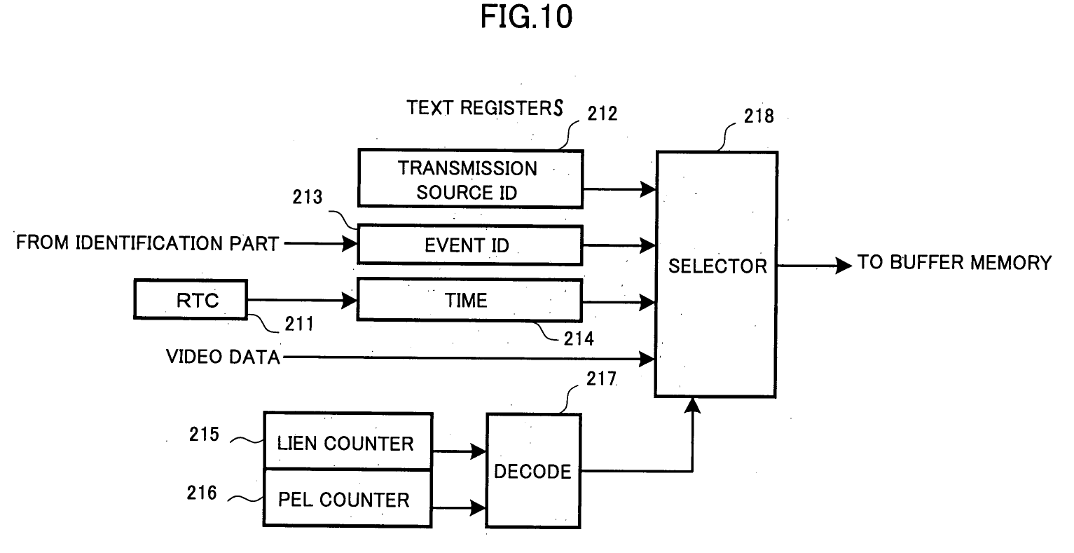

With reference to FIGS. 9 and 10, the function of the OSD part 20 in the above-mentioned fourth embodiment will now be described. FIG. 9 shows a state in which text data is multiplexed or inserted into a still image which is each video frame, while FIG. 10 shows an internal block diagram of the OSD part 20. As shown in FIG. 10, the OSD part 20 includes a RTC (real time clock) 211, a transmission source ID part 212, an event ID part 213 and a time part 214 as text data registers, a line counter 215, a pel counter 216, a decoder 217 and a selector 218.

In case of performing text multiplexing or text insertion into each moving picture frame so as to insert respective ones of identification information such as a transmission source ID, an event ID and a time, the respective text information to be multiplexed is stored in the respective ones of the transmission source ID part 121, event ID part 213 and time part 214. On the other hand, still image data of the relevant video frame is sent to the selector 218 for each pixel in sequence. The line counter 215 and pel counter 216 count the line number and pel number for each pixel of the video frame thus input to the selector 218. The decoder 217 switches the output of the selector 218 into the stored data of the above-mentioned text registers 212, 213 and 214 when the thus-counted line number and pel number correspond to a pixel position corresponding to a predetermined text multiplexing position. Thereby, at predetermined coordinate positions in the video frame, the relevant text information is multiplexed, and the thus-obtained pixel data is written in the buffer memory 19 in sequence.

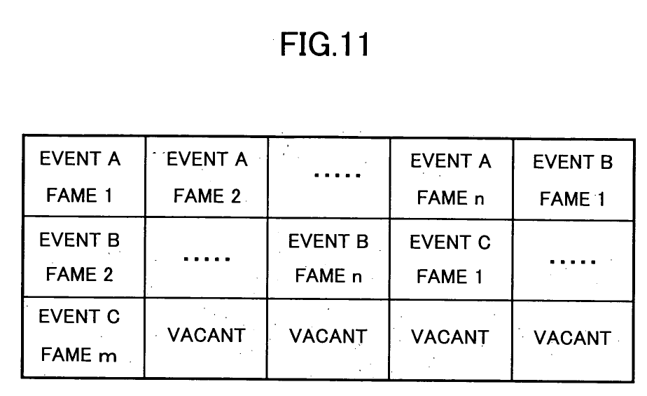

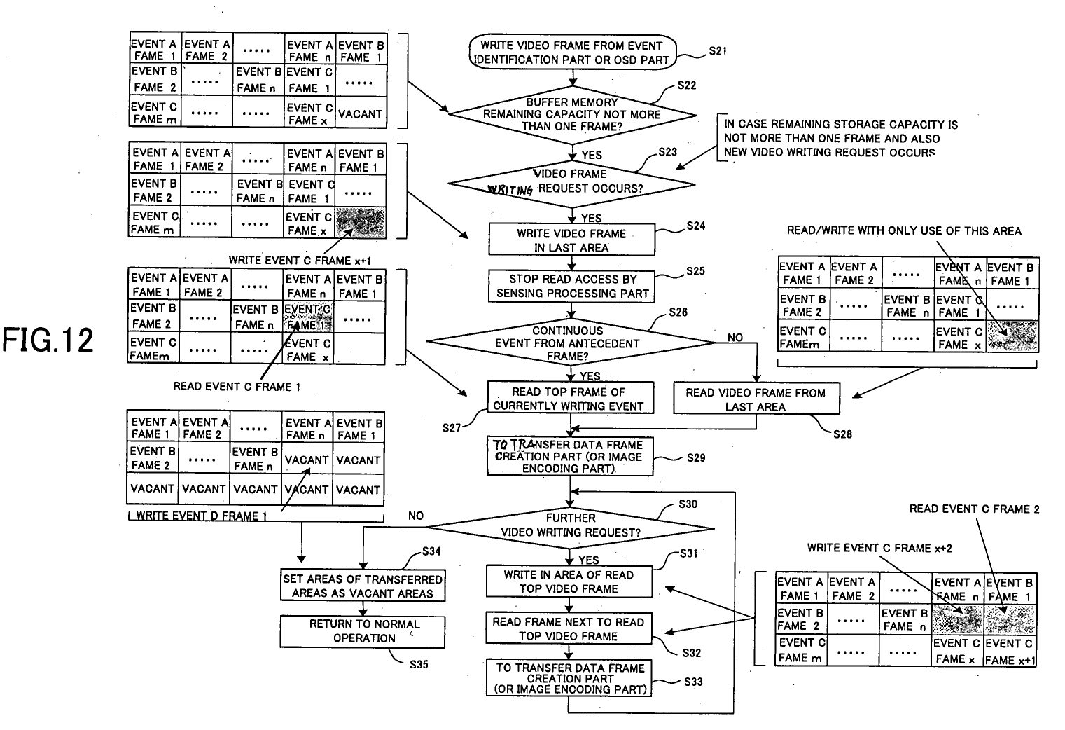

With reference to FIGS. 11 and 12, the functions of the memory controller 13, sharing processing determination part 14 and buffer memory 19 in each image sensor-apparatus in each embodiment described above will now be described.

FIG. 11 illustrates a configuration of storage areas in the buffer memory 19. As shown, the buffer memory 19 can store therein a plurality of video frames at a time, and has a function of storing data in sequence according to the order of respective addresses of the storage areas upon writing therein of given video frames (for example, made of an SDRAM). The memory controller 13 always manages a writing start address (write point) and a reading start address (read point) in the storage areas in the buffer memory 19.

In the buffer memory 19, as mentioned above, video frames input from the event identification part 12 are written in sequence according to the address order, while the thus-written video frames are read out therefrom by the sensing processing part 15 according to the address order. The above-mentioned writing start address is the address in the buffer memory 19 at which, currently, the video data is written, while the reading start address is the address in the buffer memory 19 at which the video data is read out currently. In this case, there should occur no problem as long as the reading start address is sufficiently antecedent with respect to the writing start address. However, when the reading start address is caught up with by the writing start address, the video frame which is not yet read out by the sensing processing part 15 would be overwritten if the writing into the buffer memory 19 were further continued. If so, the video frame thus overwritten and thus erased cannot undergo the predetermined analysis processing by the sensing processing part 15.

In order to avoid such a problematic situation, the memory controller 13 always monitors the difference between the writing start address and reading start address, i.e., the remaining storage capacity of the buffer memory 19, and, when the thus-monitored value becomes less than a predetermined value, the image sensor apparatus 1 determines that it has an amount of to-be-processed data which exceeds its own data processing capability, and then, executes processing of transferring the excessive to-be-processed data to another image sensor apparatus. The memory controller 13 manages video data for each event unit with the address of the top frame of a series of frames, for example, frames f2 through f4 or frames f7 through f7 for each event shown in FIG. 7, and, in a case of the above-mentioned determination being made that the to-be-processed data exceeds, the video data read out from addresses including the top address for a subsequent event is then transferred to another image sensor apparatus via the transfer frame creation part 16 instead of being transferred to the sensing processing part 15 in the own apparatus.

With reference to FIG. 12, this operation will now be descried specifically. In the buffer memory 19, as shown in FIG. 11, writing data is mapped in the order of time sequence for each frame, and, same as a well-known FIFO, overwriting is performed from the first address after the writing is finished up to the last address of the memory. Thus, the buffer memory 19 is assumed to have a configuration of a so-called ring buffer.

In FIG. 12, in Step S22, it is determined whether or not the remaining storage capacity is not more than 1 frame. When it is not more than 1 frame, it is further determined whether or not there still occurs video frame writing request in Step S23. When the result of Step S23 is Yes, the relevant video frame is written at an address which is a last writeable one area as the remaining storage capacity (in Step S24), and also, transfer of read-out video image to the sensing processing part 15 is stopped in Step S25. Then, in Step S26, it is determined whether or not the event is same as that of the immediately antecedent video frame, i.e., whether or not the taken target object coincides with each other. At a time of coincidence (Yes), all the frames of the unit data concerning the relevant event (frames 1 through x of event C in case shown in FIG. 12) should be transferred to another image sensor apparatus. For this purpose, reading is started from the first frame (frame 1 of event C) concerning the event of video data currently written, in Step S27.

On the other hand, in case where the event of the relevant frame is different from that of the immediately antecedent frame as a result of determination in Step S26 (No), the unit data concerning the new event only including a series of frames starting from the relevant frame should be transferred to another image sensor apparatus. For this purpose, the frame written at the last address of the remaining storage area in Step S24 is read out in Step S28. In this case, each video frame input subsequently is then written in and read out alternately from the buffer memory 19 with a use of this same storage area at the above-mentioned last address of the remaining storage capacity repetitively, and then, the read out video data fame is transferred to the other image sensor apparatus in sequence via the transferred data creation part or image encoding part 16.

Then, in Step s29, in order to transfer to the other image sensor apparatus, the video frame read out in the immediately antecedent step is transferred to the transfer frame creation part or image encoding part 16. In Step S30, it is determined whether or not video frame writing request further occurs. When it occurs (Yes), the video frame relevant to this new writing request is written in Step S31 in the storage area at the address from which the video frame is read in Step S27, as shown in FIG. 12. After that, the video frame is read out at the address subsequent to the above-mentioned address, and is transferred to the transfer data creation part or image encoding part 16 in Step S32. However, in the case where the video frame is read out in Step S28, and is transferred to the transfer frame creation part or image encoding part 16 to be transferred to the other image sensor apparatus, the video data relevant to the new writing request is written into and read out therefrom alternately with a use only of the same storage area for one frame as mentioned above, and then it is transferred into the transfer frame creation part or image encoding part 16 in the same manner (Step S32).

The above-mentioned processing (Steps S31, S32 and S33) is repeated until the determination result of Step S30 becomes No. In other words, the processing is continued until the new writing request breaks. After the breaking, the storage areas having stored the data unit including the series of frames (video data of event C) which has been transferred to the other image sensor apparatus via the transfer frame creation part or image encoding part 16 in the above-mentioned processing are then newly set as a remaining storage capacity in the buffer memory 19 in Step S34. Then, a subsequent processing follows in Step S35. That is, upon receiving a new video frame writing request, writing is started from the top address of the remaining storage capacity newly set as mentioned above, while video data then read out from the buffer memory 19 is transferred to the sensing processing part 15, and undergoes the video data analysis in the predetermined sensing processing in the sensing processing part 15.

However, in case where the video frame was read out in Step S28 so as to be transferred to the other image sensor apparatus via the transfer frame creation part or image encoding part 16 as mentioned above, the above-mentioned buffering is performed with a use of only the remaining storage capacity of one frame until new writing request breaks. In this case, in a stage in which the new writing request breaks (No in Step S30), the newly set remaining storage capacity set in Step S34 includes a sum of the above-mentioned remaining storage area of one frame and remaining storage areas which occur as a result of data reading performed during an interval occurring after the above-mentioned breaking of new writing request. Then, in this case, in Step S35, upon occurrence of a new writing request, writing is started from the top address of the thus-set remaining storage capacity, while reading is performed with continuous execution of the reading operation which has been performed during the above-mentioned interval occurring after the break of new writing request.

Thus, it is possible to determine whether or not an amount of to-be-processed data which exceeds the processing capability occurs in the image sensor apparatus 1 by a relatively simple determination operation by management of the reading start address and writing start address in the buffer memory 19. In case where to-be-processed data exceeding the processing capability occurs, the exceeding amount of to-be-processed data is transferred to another image sensor apparatus. As a result, it is possible to avoid a situation in which not-yet-read-out video data is overwritten with newly written video data and is thus discarded so that a lack of analysis processing occurs.

The function of the transfer data frame creation part 16 will now be described. First, a case where this functional part is configured as an MPEG encoding part will now be described. In this case, a data unit including a series of frames for each event is encoded as one sequence. According to the embodiment of the present invention, as described above with reference to FIG. 7, a short sequence occurs for each data unit intermittently. Therefore, a program stream (PS) is applied as the MPEG system multiplexing stream therefor. Further, in this case, as mentioned above, the transmission source ID, event ID, time information and so forth used as the identification information are multiplexed as private data in the MPEG stream. However, in case where the text multiplexing/insertion with a use of the OSD part 20 described above is employed for inserting the identification information, the above-mentioned processing of multiplexing the identification information as private data is not needed.

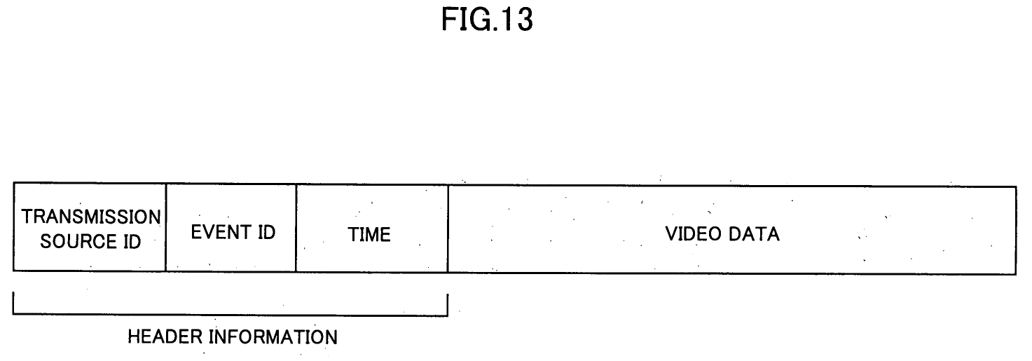

As another alternative, it is also possible to create the transfer data frame including the identification information as header information in addition to video data as shown in FIG. 13 separately without employing the above-mentioned method of multiplexing the identification information as private data. The header information is transmitted to the center apparatus 2 together with the sensing processing result provided by the sensing processing part 15 in this case. Accordingly, the center apparatus 2 can easily search for the sensing processing result for a particular event with a use of the header information. In case of employing the method of text multiplexing by the OSD part 20 or the method of multiplexing as private data in the MPEG stream, the identification information can be easily obtained from analysis of the transferred data itself. Accordingly, the header information is not needed in this case, and thus, special processing of creating the transfer data frame shown in FIG. 13 is not needed either.

The configuration of the transfer data frame analysis part 18 shown in FIGS. 4 through 6 will now be described. When transferred data coming from another apparatus is received via the network 3 with the network IF part 17, this matter is reported to the sharing processing determination part 14. The sharing processing determination part 14 determines whether or not any not-yet-read-out video data remains in the buffer memory 19 in the own apparatus. If there is no remaining video data in the buffer memory 19, the thus-received transferred data is accepted to be processed by this image sensor apparatus instead of the transmission source apparatus. In this case, the header information is removed from the transferred data, and both of data are transferred to the sensing processing part 15 separately, and the sensing analysis processing is performed on the transferred data by the sensing processing part 15.

On the other hand, in case where there remains not-yet-read-out video data in the buffer memory 19 in the own apparatus, the sharing processing determination part 14 does not accept the received transferred data, and then, further transfers the transferred data to another image sensor apparatus.

In case where the received transferred data is the MPEG coded data, the image decoding part 18 as the transfer data analysis part decodes it, and transfers the video data and the identification information obtained from the decoding to the sensing processing part 15. On the other hand, in case the identification information is not multiplexed to the MPEG coded data as private data, it is determined that the identification information is inserted into the video frame itself by means of a text multiplexing technique. In this case, only the decoded data is transferred to the sensing processing part 15. Generally speaking, in such a case, information inserted by means of the text multiplexing technique is an image having a simple configuration such as numerals or so, and also, the coordinates in the frame at which the information is multiplexed is predetermined. Accordingly, the information multiplexed can be easily obtained from a simple image analysis such as a well-known pattern matching technique or so.

Thus, according to the present invention, a high data processing capability should not necessarily be required in each particular data processing apparatus, it is possible to effectively share the data processing load by transferring to-be-processed data to another apparatus via the network for each predetermined data unit as the necessity arises, and thus, it is possible to execute the required amount of data processing in real time positively without fail even in response to a burst of successively occurring events to be handled.

Further, the present invention is not limited to the above-described embodiments, and variations and modifications may be made without departing from the basic concept of the present invention recited in the following claims.

The present application is based on Japanese priority application No. 2003-076335, filed on Mar. 19, 2003, the entire contents of which are hereby incorporated by reference.

What is claimed is:

1. A data processing system in which a plurality of data processing apparatuses are connected together via a communication network, wherein:
each of said plurality of data processing apparatuses comprises:
a data acquisition part obtaining data which should be processed;
a data analysis part performing predetermined data analysis on the obtained data;
a data unit identification part identifying the obtained data as a data unit for each event; and
a determining unit determining for each data unit according to a predetermined condition whether the predetermined data analysis should be performed on the obtained data in the own apparatus, or should be sent via the communication network to another apparatus and the predetermined data analysis should be performed by said other apparatus instead on the obtained data.

2. The data processing system as claimed in claim 1, wherein:
the data obtained by each data processing apparatus comprises moving picture data as a monitoring target concerning a predetermined monitoring item; and
the predetermined data analysis which should be performed by said data analysis part comprises processing of determining and recognizing the contents of the predetermined monitoring item by analyzing the obtained moving picture data.

3. The data processing system as claimed in claim 2, wherein:
each data processing apparatus further comprises an identification information adding part adding predetermined identification information to the obtained moving picture data, which information is used for identifying the obtained moving picture data for each event as a data unit; and
the predetermined identification information is added to the moving picture data in a form of private data when the moving picture data is compressed.

4. The data processing system as claimed in claim 2, wherein:
each data processing apparatus further comprises an identification information adding part adding predetermined identification information to the obtained moving picture data, which information is used for identifying the obtained moving picture data for each event as a data unit; and
the identification information is inserted into each frame of the moving picture data by a predetermined text multiplexing technique.

5. A data processing apparatus comprising:
a data acquisition part obtaining data which should be processed;
a data analysis part performing predetermined data analysis on the obtained data;
a data unit identification part identifying the obtained data for each event as a data unit; and
a determining unit determining for each data unit according to a predetermined condition whether the predetermined data analysis should be performed on the obtained data in the own apparatus, or transferring the obtained data via a communication network to another apparatus and causing the other apparatus instead to perform the predetermined data analysis on the obtained data therein.

6. The data processing apparatus as claimed in claim 5, wherein:
the data obtained comprises moving picture data as a monitoring target concerning a predetermined monitoring item; and
the predetermined data analysis which should be performed by said data analysis part comprises processing of determining and recognizing the contents of the predetermined monitoring item by analyzing the obtained moving picture data.

7. The data processing apparatus as claimed in claim 6, further comprising an identification information adding part adding predetermined identification information to the obtained moving picture data, which information is used for identifying the obtained moving picture data for each event as a data unit,
wherein the predetermined identification information is added to the moving picture data in a form of private data when the moving picture data is compressed.

8. The data processing apparatus as claimed in claim 6, further comprising an identification information adding part adding predetermined identification information to the obtained moving picture data, which information is used for identifying the obtained moving picture data for each event as a data unit,
wherein the predetermined identification information is inserted into each frame of the moving picture data by a predetermined text multiplexing technique.

9. A data processing method applied to a data processing system in which a plurality of data processing apparatuses are connected together via a communication network, comprising the steps of:
a) obtaining data which should be processed by each of said plurality of data processing apparatuses;
b) performing predetermined data analysis on the obtained data in said data processing apparatus;
c) identifying the obtained data for each event as a data unit in said data processing apparatus; and
d) determining for each data unit according to a predetermined condition whether to perform the predetermined data analysis on the obtained data in said data processing apparatus, or to send via the communication network the obtained data to another apparatus and causing said another apparatus instead to perform thereon the predetermined data analysis.

10. The data processing method as claimed in claim 9, wherein:
the data obtained by each data processing apparatus comprises moving picture data as a monitoring target concerning a predetermined monitoring item; and
the predetermined data analysis which should be performed in said step b) comprises processing of determining and recognizing the contents of the predetermined monitoring item by analyzing the obtained moving picture data.

11. The data processing method as claimed in claim 10, further comprising the step of e) adding predetermined identification information to the obtained moving picture data, which information is used for identifying the obtained moving picture data for each event as a data unit,
wherein the predetermined identification information is added to the moving picture data in a form of private data when the moving picture data is compressed.

12. The data processing method as claimed in claim 10, further comprising the step of e) adding predetermined identification information to the obtained moving picture data, which information is used for identifying the obtained moving picture data for each event as a unit data,
wherein the predetermined identification information is inserted into each frame of the moving picture data by a predetermined text multiplexing technique.
